(19) United States
(12) Patent Application Publication
(10) Pub. No.: US 2017/0187097 A1
(43) Pub. Date: Jun. 29, 2017

(54) MOBILE TERMINAL AND GPS ANTENNA OF MOBILE TERMINAL

(71) Applicants: LE HOLDINGS (BEIJING) CO., LTD., Beijing (CN); LEMOBILE INFORMATION TECHNOLOGY (BEIJING) CO., LTD., Beijing (CN)

(72) Inventor: Biao LI, Beijing (CN)

(21) Appl. No.: 15/244,176

(22) Filed: Aug. 23, 2016

Related U.S. Application Data
(63) Continuation of application No. PCT/CN2016/088781, filed on Jul. 6, 2016.

(30) Foreign Application Priority Data
Dec. 29, 2015 (CN) 2015110167176

(51) Int. Cl. H01Q 1/24; H01Q 1/38; H01Q 1/48

(52) U.S. Cl. CPC H01Q 1/243; H01Q 1/48; H01Q 1/38

(57) ABSTRACT

Disclosed is a mobile terminal which comprises a GPS antenna, a back cover and a main board. The GPS antenna comprises a metallic radiation layer and a metallic grounding layer configured on a surface of the back cover, the metallic radiation layer and the metallic grounding layer are separated by insulating materials, the main board is provided with a feed wire and a ground wire; the metallic radiation layer is provided with a feed portion, the feed portion is connected to the feed wire which is on the main board, the feed portion serves as a radiation body of the GPS antenna, the metallic grounding layer is provided with a grounding portion, the grounding portion is connected to the ground wire which is on the main board, the grounding portion is used for grounding the GPS antenna, and the grounding portion is connected to the ground wire of the main board via a plurality of points of contact.

### CROSS REFERENCE TO RELATED DISCLOSURES

The present application is a continuation of PCT application which has an application number of PCT/CN2016/088781 and was filed on Jul. 6, 2016. The present application claims the priority of a Chinese patent application titled “mobile terminal and GPS antenna of a mobile terminal”, which was filed with the Chinese Patent Office on Dec. 29, 2015 and has an application number of 201511016717.6, the contents of which are incorporated by reference herein in its entirety.

### TECHNICAL FIELD

The present application relates to the technological field of antennas, mobile terminals and GPS antennas of mobile terminal in particular.

### BACKGROUND

Global Positioning System (GPS) is a new-generation satellite navigation positioning system developed by the United States Department of Defense for the United States Army, Navy and Air Force, and has been extensively applied to many areas such as navigation, surveying and mapping, monitoring, timing and communication. In recent years, GPS develops rapidly in the civil field, and particularly has demonstrated great potential in navigation and positioning. In response to demands of recent GPS applications, GPS antenna is one of key issues which must be addressed.

A GPS antenna is built in a conventional mobile terminal (e.g. a mobile phone). Although it is not perfect in relation to positioning, timing, precision and response speed, the technology is fairly developed. A clearance area on a printed circuit board of a mobile terminal is usually left and kept in order to satisfy potential demands from users, in addition to adopting a linearly-polarized (namely, horizontal polarization or vertical polarization) small antenna of antenna type such as Planar Inverted-F Antenna (PIFA), monopole or Inverted-F antenna (IFA).

However, a signal transmitted by a GPS satellite is a right-hand circularly-polarized wave whereas the antenna of the mobile terminal is a linear polarization antenna, and inconsistent polarization brings about energy loss (approximately 3 dB) upon reception of the signal. Energy loss caused by inconsistency of polarization therefore must be reduced by further improving the efficiency of antenna. Meanwhile, regarding mobile terminals, a fashionable metallic case also brings about a serious challenge for antenna design. From a prospective of material, the metallic casing, more or less, shields radio signals. It is hoped that, by constantly improving antenna design, we can improve sensitivity of the GPS antenna and overcome problems which are caused by the metallic casing.

### SUMMARY

In view of the above, the present application is to provide a mobile terminal and a GPS antenna thereof. To solve the above issues, a metallic case is used as a radiation body and grounding body of the antenna, provided that the grounding body employs an approach of multi-contact grounding.

According to an aspect of the present application, a mobile terminal is provided, comprising: a GPS antenna, a back cover and a main board, the said GPS antenna comprises a metallic radiation layer and a metallic grounding layer, the said metallic radiation layer and the said metallic grounding layer are configured on a surface of the said back cover, the said metallic radiation layer and the said metallic grounding layer are separated by insulating materials, the said main board is provided with a feed wire and a ground wire; the said metallic radiation layer is provided with a feed portion, the said feed portion is connected to the feed wire which is on the said main board, the said feed portion serves as a radiation body of the said GPS antenna, the said metallic grounding layer is provided with a grounding portion, the said grounding portion is connected to the ground wire which is on the said main board, the said grounding portion is used for grounding the said GPS antenna, and the said grounding portion is connected to the ground wire of the said main board via a plurality of points of contact.

According to another aspect of the present application, a GPS antenna of mobile terminal is provided, comprising: a metallic radiation layer and a metallic grounding layer, the said metallic radiation layer and the said metallic grounding layer are configured on the back cover surface of the mobile terminal, the said metallic radiation layer and the said metallic grounding layer are separated by insulating materials, the said metallic radiation layer is provided with a feed portion, the said feed portion is connected to the feed wire which is on the main board of the mobile terminal, the said feed portion serves as a radiation body of the said GPS antenna, the said metallic grounding layer is provided with a grounding portion, the said grounding portion is connected to the ground wire which is on the main board of the mobile terminal, the said grounding portion is used for grounding the said GPS antenna, and the said grounding portion is connected to the ground wire of the main board of the mobile terminal via a plurality of points of contact.

There is provided, by embodiments of the present application, a mobile terminal which comprises a GPS antenna, a back cover and a main board, the said GPS antenna comprises a metallic radiation layer and a metallic grounding layer configured on a surface of the said metallic radiation layer and the said metallic grounding layer are separated by insulating materials, the said main board is provided with a feed wire and a ground wire; the said metallic radiation layer is provided with a feed portion, the said feed portion is connected to the feed wire which is on the said main board, the said feed portion serves as a radiation body of the said GPS antenna, the said metallic grounding layer is provided with a grounding portion, the said grounding portion is connected to the ground wire which is on the said main board, and the said grounding portion is used for grounding the said GPS antenna, wherein the said grounding portion is connected to the ground wire of the said main board via a plurality of points of contact. The approach of multi-contact grounding changes the distribution of grounding current of a mobile phone GPS antenna; it reduces the carrier-to-noise ratio of GPS signals and thereby improves the sensitivity of a GPS antenna of mobile phone.

### BRIEF DESCRIPTION OF THE DRAWINGS

One or more embodiments is/are accompanied by the following figures for illustrative purposes and serve to only to provide examples. These illustrative descriptions in no way limit any embodiments. Similar elements in the figures are denoted by identical reference numbers. Unless it states the otherwise, it should be understood that the drawings are not necessarily proportional or to scale.

FIG. 1 is a schematic view of an outer surface of a mobile phone back cover according to an embodiment of the present application;

FIG. 2 is a schematic view of an inner surface of a mobile phone back cover according to an embodiment of the present application.

Wherein, reference numbers in the figures designate the following parts:
100. metallic radiation layer
101. metallic grounding layer
102. insulating slit
103. mobile phone main board
S1. feed portion
S2. grounding portion

### DETAILED DESCRIPTION

Exemplary embodiments of the present application will be described in more detail below with reference to the figures. Although the figures illustrate exemplary embodiments of the present application, it should be appreciated that the present application may be implemented in various forms and should not be limited by embodiments herein. On the contrary, these embodiments provide for complete understanding of the present application, and are sought to fully convey the scope of this application to those skilled in the art.

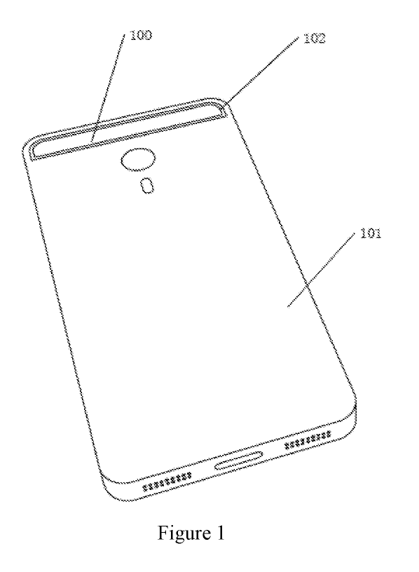

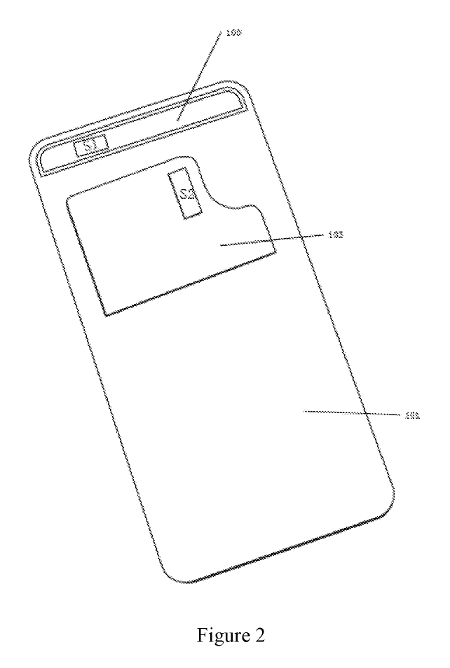

In preferred embodiments below, a mobile phone is taken as an example in the exemplary depiction of the present application. Those skilled in the art may appreciate that different designs of embodiment within the present application apply to other mobile terminals. FIG. 1 and FIG. 2 are respectively a schematic view of an outer surface of a mobile phone back cover and of an inner surface of a mobile phone back cover according to an embodiment of the present application. As shown in FIGS. 1, 100 and 101 are, respectively, a metallic radiation layer and a metallic grounding layer, the metallic radiation layer 100 and the metallic grounding layer 101 are configured on the outer surface of a mobile phone back cover, wherein the metallic radiation layer 100 and the metallic grounding layer 101 are spaced apart by insulating materials, between which 102 is a slit. The above insulating materials can be any insulating materials such as plastic.

As shown in FIG. 2, a feed portion S1 is configured on the metallic radiation layer 100 of the inner surface of the mobile phone, the feed portion S1 is connected to a feed wire on a mobile phone main board 103, the metallic radiation layer 100 is used as a radiation body of the GPS antenna to radiate electrical signals transmitted on a main board circuit and receive GPS signals. A grounding portion S2 is configured on the metallic grounding layer 101, and it is connected to a ground wire of the mobile phone main board via a plurality of points of contact.

In an embodiment of the present application, to utilize stronger and more stable properties of radiation performance of a loop antenna, positions of the feed portion S1 and grounding portion S2 are selected carefully so that an antenna radiation area surrounded by the feed portion S1, the metallic radiation layer 100, the grounding portion S2 and the metallic grounding layer 101 is an annular area, thereby optimizing sensitivity of the GPS antenna.

As for manufacturing, S1 is designed as a GPS feed area on the metallic back cover of a mobile phone. It is achieved by a manufacturing process such as laser caving and electroplating, and it is conductively communicated with the mobile phone main board via the elastic sheets. In a preferred embodiment, the on-resistance is less than or equal to 0.5 Ohm in order to ensure an excellent conductivity of the elastic sheets and the radiation body of the mobile phone antenna.

S2 may be conductive foam of a high density; the metallic back cover of the mobile phone is connected to the main board via wires in the foam. After radiation is formed, sensitivity of the GPS reception is optimized by adjusting the density of wires in the conductive foam, namely the density of points of contact connected to the main board ground wire. Distribution of grounding currents can be varied by altering the density of points of contact. Even distribution of grounding currents reduces the carrier-to-noise ratio of GPS signals and it consequently improves the sensitivity of a GPS antenna.

As another optional solution, S2 may be a plurality of elastic sheets connecting the main board and the metallic back cover of a mobile phone.

It has been discovered, by comparing sensitivities of GPS antennas each of which has one, four or even more points of contact, that increase of the number of points of contact can improve the sensitivity of a GPS antenna. The GPS carrier-to-noise ratio CN0 is increased by 3-5 dBm by increasing the density of wires of the grounding foam, and the sensitivity of the GPS antenna is improved by reducing the carrier-to-noise ratio.

In another optional embodiment, positions of the grounding portion and the feed portion are both determined by taking account of the working frequency bands of GPS. It has been discovered by experiment that when the optimal distance between the central point of the conductive foam of the grounding portion and the bottom end of the feed portion is approximately ½ of the wavelength of the working frequency band of GPS, the optimal receiving effect of a GPS antenna can be achieved.

L1 carrier signals transmitted by a GPS satellite and to be received by a mobile phone antenna has a frequency of 1575.42 MHz and a wavelength of 19.03 cm. By dividing the above wavelength by 2, positions of the grounding portion and the feed portion can be set. In practice, error rates are set based on actual situations.

In addition, a GPS antenna of mobile terminal is proposed according to the above mobile terminal. The GPS antenna comprises a metallic radiation layer and a metallic grounding layer, the metallic radiation layer and the metallic grounding layer are configured on the back cover surface of a mobile terminal, the metallic radiation layer and the metallic grounding layer are separated by insulating materials, the metallic radiation layer is provided with a feed portion, the feed portion is connected to the feed wire which is on the main board of the mobile terminal, the feed portion serves as a radiation body of the GPS antenna, the metallic grounding layer is provided with a grounding portion, the grounding portion is connected to the ground wire which is on the main board of the mobile terminal, the grounding portion is used for grounding the GPS antenna, and the grounding portion is connected to the ground wire of the main board of the mobile terminal via a plurality of points of contact.

In an optional embodiment, the feed portion of the GPS antenna is connected to the feed wire on the mobile terminal main board via elastic sheets.

In an optional embodiment, the grounding portion of the GPS antenna is spaced apart from the feed portion. The optimal receiving effect of a GPS antenna can be achieved, when the distance between the central point of the grounding portion and the bottom end of the feed portion is ½ of the wavelength of the working frequency band of GPS.

Embodiments of the present application provide a mobile terminal which comprises a GPS antenna, a back cover and a main board, the said GPS antenna comprises a metallic radiation layer and a metallic grounding layer, the metallic radiation layer and the metallic grounding layer are configured on a surface of the said back cover, the said metallic radiation layer and the said metallic grounding layer are separated by insulating materials, the said main board is provided with a feed wire and a ground wire; the said metallic radiation layer is provided with a feed portion, the said feed portion is connected to the feed wire which is on the said main board, the said feed portion serves as a radiation body of the said GPS antenna, the said metallic grounding layer is provided with a grounding portion, the said grounding portion is connected to the ground wire which is on the said main board, and the said grounding portion is used for grounding the said GPS antenna, wherein the said grounding portion is connected to the ground wire of the said main board via a plurality of points of contact.

It is appreciated that, by adopting an approach of multi-contact grounding, flow direction of grounding currents of a mobile phone GPS antenna can be altered so as to improve the sensitivity of the GPS antenna.

In an optional embodiment, the grounding portion is foam which comprises a plurality of points of contact, and the said a plurality of points of contact are a plurality of wires inside the foam.

In another optional embodiment, the said grounding portion is a plurality of elastic sheets.

In another optional embodiment, the said feed portion is connected to the feed wire on the said main board via the elastic sheets.

In another optional embodiment, the said grounding portion is spaced apart from the said feed portion.

In another optional embodiment, the distance between the central point of the said grounding portion and the bottom end of the said feed portion is ½ of the wavelength of GPS working frequency.

In another optional embodiment, the on-resistance of the said feed portion is less than or equal to 0.5 Ohm.

In another optional embodiment, the back cover is a back cover made of metallic materials.

What have been described above are preferred embodiments of the present application, none of which intends to limit the scope of the present application. Those skilled in the art appreciate that the present application may be modified and has variations. Any modifications, equivalent substitutes and improvements within the spirit and principles of the present application all fall within the protection scope of the present invention.

What is claimed is:

1. A mobile terminal, comprising: a GPS antenna, a back cover and a main board, wherein the said GPS antenna comprises a metallic radiation layer and a metallic grounding layer, the said metallic radiation layer and the said metallic grounding layer are configured on a surface of the said back cover, the said metallic radiation layer and the said metallic grounding layer are separated by insulating materials, the said main board is provided with a feed wire and a ground wire; the said metallic radiation layer is provided with a feed portion, the said feed portion is connected to the feed wire which is on the said main board, the said feed portion serves as a radiation body of the said GPS antenna, the said metallic grounding layer is provided with a grounding portion, the said grounding portion is connected to the ground wire which is on the said main board, the said grounding portion is used for grounding the said GPS antenna, and the said grounding portion is connected to the ground wire of the said main board via a plurality of points of contact.

2. The mobile terminal according to claim 1, wherein the said grounding portion is foam which comprises a plurality of points of contact, and the said a plurality of points of contact are a plurality of wires inside the said foam.

3. The mobile terminal according to claim 1, wherein the said grounding portion is a plurality of elastic sheets.

4. The mobile terminal according to claim 1, wherein the said feed portion is connected to the feed wire on the said main board via the elastic sheets.

5. The mobile terminal according to claim 1, wherein the said grounding portion is spaced apart from the said feed portion.

6. The mobile terminal according to claim 5, wherein the distance between the central point of the said grounding portion and the bottom end of the said feed portion is ½ of the wavelength of GPS working frequency.

7. The mobile terminal according to claim 1, wherein the on-resistance of the said feed portion is less than or equal to 0.5 Ohm.

8. The mobile terminal according to claim 1, wherein the said back cover is a back cover made of metallic materials.

9. A GPS antenna of a mobile terminal, comprising: a metallic radiation layer and a metallic grounding layer, the said metallic radiation layer and the said metallic grounding layer are configured on the back cover surface of the mobile terminal, the said metallic radiation layer and the said metallic grounding layer are separated by insulating materials, the said metallic radiation layer is provided with a feed portion, the said feed portion is connected to the feed wire which is on the main board of the mobile terminal, the said feed portion serves as a radiation body of the said GPS antenna, the said metallic grounding layer is provided with a grounding portion, the said grounding portion is connected to the ground wire which is on the main board of the mobile terminal, the said grounding portion is used for grounding the said GPS antenna, and the said grounding portion is connected to the ground wire of the main board of the mobile terminal via a plurality of points of contact.

10. The GPS antenna according to claim 9, wherein the said grounding portion is foam which comprises a plurality of points of contact, and the said a plurality of points of contact are a plurality of wires inside the said foam.

11. The GPS antenna according to claim 9, wherein the said grounding portion is a plurality of elastic sheets.

12. The GPS antenna according to claim 9, wherein the said feed portion is connected to the feed wire on the said main board via the elastic sheets.

13. The GPS antenna according to claim 9, wherein the said grounding portion is spaced apart from the said feed portion.

14. The GPS antenna according to claim 13, wherein the distance between the central point of the said grounding portion and the bottom end of the said feed portion is ½ of the wavelength of GPS working frequency.

15. The GPS antenna according to claim 9, wherein the on-resistance of the said feed portion is less than or equal to 0.5 Ohm.
